(19) United States
(12) Patent Application Publication
(10) Pub. No.: US 2001/0019778 A1
(43) Pub. Date: Sep. 6, 2001

(54) Multilayer non-stick coating of improved hardness for aluminum articles and articles and culinary utensils incorporating such coating

(75) Inventors: Claudine Gardaz, Bloye (FR); Jean-Pierre Buffard, Aix-Les-Bains (FR)

Correspondence Address: PERMAN & GREEN, 425 POST ROAD, FAIRFIELD, CT, 06430, US

(73) Assignee: SEB S.A.

(21) Appl. No.: 09/757,918

(22) Filed: Jan. 10, 2001

Related U.S. Application Data
(63) Continuation-in-part of application No. 09/150,326, filed on Sep. 9, 1998, now abandoned.

(30) Foreign Application Priority Data
Sep. 10, 1997 (FR) 97 11242

(51) Int. Cl. B32B 9/00; B05D 1/22

(52) U.S. Cl. 428/524; 428/469; 428/472; 427/458; 427/421

(57) ABSTRACT

A multilayer non-stick coating of improved hardness for aluminum articles includes an alumina-based hard first layer obtained by anodic oxidation of the aluminum article immersed in an alkaline solution. Micro-arcs are applied to the article by means of a high current and a high potential difference. A second polytetrafluoroethylene-based layer constitutes a primer for one or more polytetrafluoroethylene-based finish layers.

This application is a continuation-in-part of application Ser. No. 09/150,326, filed Mar. 8, 2000 which in turn is a Continuation Application of application Ser. No. 09/150,326, filed Sep. 9, 1998.

### BACKGROUND OF THE INVENTION

1. Field of the Invention

The present invention relates to a multilayer non-stick coating of improved hardness for aluminum or aluminum alloy articles, for producing coated articles having increased resistance to scratching and wear.

The present invention also relates to a method for manufacturing aluminum articles coated with a multilayer non-stick coating, said coated articles having increased resistance to scratching and wear.

The invention is also directed to aluminum or aluminum alloy articles and in particular culinary utensils incorporating a coating in accordance with the invention.

2. Description of the Prior Art

Coatings based on polytetrafluoroethylene (PTFE) applied to the inside and/or outside surface of aluminum culinary utensils have the disadvantage of being susceptible to scratching and to wear.

To overcome this disadvantage, it has previously been proposed to apply a PTFE-based coating on top of a hard underlayer obtained by anodizing the aluminum or by thermal plasma sputtering, for example.

However, these solutions have not yielded satisfactory results.

The aim of the present invention is to provide a non-stick coating for aluminum articles, capable of producing coated aluminum articles having increased resistance to scratching and wear.

### SUMMARY OF THE INVENTION

The invention relates to in a multilayer non-stick coating for aluminum articles, capable of producing coated aluminum articles having increased resistance to scratching and wear, and also relates to such coated articles. The present coating includes the following layers:

a hard first layer comprising mainly α alumina and a low percentage of γ alumina covered with a surface layer of mullite, the hard first layer being obtained by anodic oxidation of the aluminum article immersed in an alkaline solution during application of micro-arcs to said article by means of a high current and a high potential difference, said mullite layer being possibly partially or totally removed, and said hard first layer having a porous nature,

a second polytetrafluoroethylene-based layer which constitutes a primer for

one or more polytetrafluoroethylene-based finished layers,

the particles of the primer second layer being lodged in pores present throughout the α alumina, γ alumina and possibly mullite hard first layer, so as to provide the coating with an extremely high resistance to removal by scratching.

The invention also relates to a method for manufacturing aluminum articles coated with a multilayer non-stick coating, said coated articles having increased resistance to scratching and wear. Said method includes the following steps:

a) producing directly on the aluminum article a hard first layer having a porous nature and comprising mainly α alumina and a low percentage of γ alumina covered with a surface layer of mullite, said hard first layer being obtained by anodic oxidation of the aluminum article immersed in an alkaline solution during application of micro-arcs to said article by means of a high current and a high potential difference,

b) applying on this hard first layer:

a second polytetrafluoroethylene-based layer which constitutes a primer for

one or more polytetrafluoroethylene-based finished layers,

the particles of polytetrafluoroethylene in the primer second layer being lodged in pores present throughout the α alumina, γ alumina and mullite hard first layer, so as to provide the coating with an extremely high resistance to scratching,

c) applying one or more polytetrafluoroethylene-based finished layers,

d) sintering the coating thus obtained.

Another embodiment of the present invention comprises a method for manufacturing aluminum articles coated with a multilayer non-stick coating, said coated article having increased resistance to scratching and wear, said method including the following steps:

a) producing directly on the aluminum article a hard porous first layer comprising a major percentage of α alumina and a low percentage of γ alumina covered with a surface layer of mullite, such hard first layer being obtained by anodic oxidation of the aluminum article immersed in an alkaline solution during application of micro-arcs to said article by means of a high current and a high potential difference,

a′) polishing the hard first layer to remove some or all of the mullite layer,

b) applying on this hard porous first layer a second polytetrafluoroethylene-based layer which constitutes a primer for one or more polytetrafluoroethylene-based finished layers, the particles of the primer second layer_being lodged in pores present throughout the hard first layer, so as to provide the coating with an extremely high resistance to scratching,

c) applying one or more polytetrafluoroethylene-based finished layers,

d) sintering the coating thus obtained.

The process for obtaining the first hard layer based on alumina is described, for example, in an article by FEDOROV and others published in 1983 in the Russian journal Physics and Chemistry of Materials Processing, under a title translating as “Composition and structure of the strength and surface layer of aluminum alloys obtained by micro-arc oxidation” and in author's certificates in the name MARKOV N^{o} 1200591 published in 1989, titled in translation “Method of application of coatings to metals and alloys”, and N^{o} 1713990 published in 1992, titled in translation “Micro-arc anodization process for metals and alloys”.

The above layer comprises α alumina and γ alumina covered with a surface layer of porous mullite (silico-alumina).

Through this process of micro-arc oxidation, the porosity of the hard first layer can be adapted. For domestic applications, a suitable porosity is between 5 and 30%, most preferably about 10%.

This hard layer is much harder and much more resistant to wear than alumina layers obtained by conventional anodization or by thermal plasma sputtering.

We have found that PTFE-based primer and finish layers applied to the alumina-based hard layer adhere very well to the latter and impart to the PTFE-based non-stick coating excellent resistance to wear and to scratching.

Other features and advantages of the invention will become apparent in the following description.

### BRIEF DESCRIPTION OF THE DRAWINGS

In the accompanying drawings, which are provided by way of non-limiting example:

FIG. 1 is a diagrammatic representation of an installation for applying a hard alumina layer to an aluminum article.

FIG. 2 is a sectional view of the hard non-stick coating of the invention.

### DETAILED DESCRIPTION OF THE PREFERRED EMBODIMENT

The application process for an aluminum article, for example a culinary utensil, will be described first.

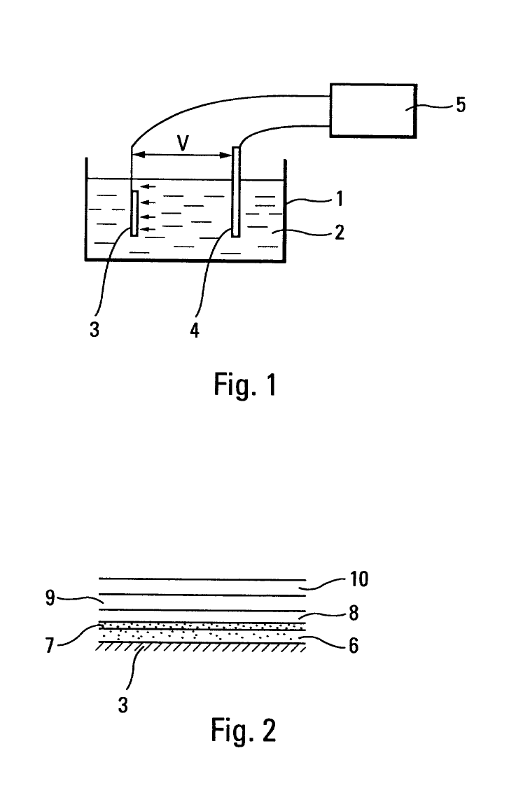

FIG. 1 shows a vat 1 containing an alkaline solution 2 into which extend an anode 3 and a cathode 4.

The anode 3 is an aluminum article, the surface of which is to be oxidized.

The anode 3 and the cathode 4 are connected to a generator 5 capable of applying a high potential difference, for example in the range 500 volts to 1000 volts, between the anode 3 and the cathode 4.

The generator 5 can also generate short pulses of high current, for example in the range of 100 A/dm²to 300 A/dm², so as to form electrical micro-arcs for oxidizing the surface of the aluminum article 3.

This oxidation forms a hard layer 6 of alumina on the surface of the article (see FIG. 2).

The layer 6 is made up mainly of α alumina and a low percentage of γ alumina.

It is covered with a surface layer 7 of mullite (silico-alumina) which is porous.

Depending on the period of application of the micro-arcs, the thickness of the hard alumina layer 6 can vary in the range 5 microns to 100 microns.

The alumina layer has a much higher hardness and a much higher resistance to wear than coatings obtained by conventional anodization or by thermal plasma sputtering. The Vickers hardness of this layer is greater than 1500 whereas that of convention ceramic layers obtained by anodization is at most equal to 450.

Besides, this hard first layer 6, 7 adheres very well on the aluminum article, even under stress or buckling.

In accordance with the invention, the following are applied to the hard layer 6, 7 obtained in this way: a second polytetrafluoroethylene-based layer 8 which constitutes a primer and then one or two polytetrafluoroethylene-based finish layers 9, 10.

Particles of PTFE of the second primer layer 8 penetrate into the pores of the hard first layer 6, 7. By a further step of sintering, solid bindings are formed among the PTFE particles present into each pore and thus create a strong mechanical anchoring between the hard first layer 6, 7 and the primer second layer 8.

In a preferred embodiment of the present invention, the primer second layer 8 further comprises conventional chemical anchoring agents known per se for their chemical anchoring ability. Such chemical anchoring agents can be colloidal silica and/or thermostable polymers such as polyamide-imide resin.

Such chemical anchoring agents also penetrate into the pores of the hard first layer 6, 7 and facilitate the anchoring among the PTFE particles.

The strong mechanical anchoring is thus reinforced by the combination with these chemical anchoring agents.

In a most preferred embodiment, the primer second layer 8 further comprises conventional technological additives known per se and commonly used for the multilayer non stick coating based on PTFE. Such additives can be chosen from the group consisting of: dispersing agents, spreading agents, wetting agents, all these agents disappearing after sintering; fillers such as pigments, . . . .

The layers 8, 9, 10 can have a total thickness in the range 5 microns to 50 microns.

The table below gives a representative example of compositions of the various layers 8, 9, 10 in the case of a non-stick coating for culinary utensils.

| | Layer 8 | Layer 9 | Layer 10 |
|---|---|---|---|
| Component | weight % | weight % | weight % |
| Silica sol precipitated to | 10-30 | 0 | 0 |
| 30% dry extract in aqueous | | | |
| Polytetrafluoroethylene, | 20-50 | 80-90 | 80-90 |
| 60% dry extract, aqueous | | | |
| dispersion | | | |
| Perfluoroalkoxy, 50% dry | 0-20 | 0 | 0 |
| extract, aqueous dispersion | | | |
| Mica flakes coated with | 0 | 0-3 | 0-3 |
| Titanium dioxide | | | |
| Iron oxide or carbon black | 0-5 | 0-0.5 | 0 |
| mineral pigments | | | |
| Emulsion of spreading | 0-15 | 10-20 | 10-20 |
| agents, 15% dry extract | | | |
| including approximately | | | |
| 5%-10% acrylic copolymers | | | |
| Polyamide-imide resin in | 0-40 | 0 | 0 |
| aqueous solution, 12% dry | | | |
| extract | | | |

After application of layers 8, 9 and 10 the coating obtained is sintered at a temperature in the range from 400° C. to 420° C. for a period in the range from 3 minutes to 10 minutes.

The PTFE particles of the primer second layer 8 possibly combined with chemical anchoring agents and/or technological additives are combining and aggregating by sintering and held in the pores of the hard first layer, thus forming a strong mechanical anchoring between the primer second layer 8 and the aluminum article 3.

After sintering the PTFE-based layer 8, 9 and 10 are found to adhere very well to the alumina-based hard layer 6, 7. This result is explained by the porous nature of the alumina and mullite layer 6, 7. Because of this, particles of PTFE in the primer layer 8 can penetrate into the pores of the mullite layer 7 and alumina layer 6. The strong anchoring of the second layer of PTFE 8 into the first layer 6, 7 assures excellent adhesion of the layer 8 while the second layer 8 remains flexible like finished layers 9, 10. The multilayer non-stick coating obtained is highly resistant to wear and scratching.

Before applying the PTFE coating 8, 9, 10 the surface can be polished to remove some of the mullite and thereby obtain a smoother surface.

The hardness of the first layer 6, 7 depends on the degree of polishing of the mullite layer 7: the more this layer 7 is polished, the harder is the first layer but with a smaller porosity. The hardest first layer is obtained by removing all the mullite layer 7. In that latter case, the hard first layer has a Vickers hardness greater than about 1500.

The PTFE coating 8, 9, 10 can be applied to the hard layer either when polished as described above or not, as previously disclosed.

Said PTFE coating 8, 9, 10 can be polished after or before sintering.

A polishing before sintering of PTFE layers 8, 9, 10 allows both a more regular surface and a better penetration of PTFE particles of the primer second layer 8 into the pores of the hard first layer. The mechanical anchoring obtained after sintering is improved.

In all cases the same result is obtained: a coating that is extremely resistant to scratching and having the non-stick properties of a conventional polytetrafluoroethylene coating, because the PTFE is lodged in or integrated with the pores present throughout the thickness of the layer of Al₂O₃ and mullite.

A cutting or sharp element provoking a cut or a scratch in the PTFE layers 8, 9, 10 will not scratch the very hard first layer 6 and possibly 7: this cut or scratch will only involve the PTFE layers 8, 9, 10 and thus will be very limited due to the flexibility and elasticity of these layers 8, 9, 10 and their strong anchoring into the hard first layer 6 and possibly 7.

Even if the second and finish layers 8, 9, 10 are scratched by a cutting tool, the scratch is stopped by the hard first layer 6 and possibly 7, and will not cut into the underlying aluminum.

For the same reasons, this coated article also has an improved resistance to abrasion.

The present invention is intended particularly for non-stick coatings of culinary articles, but applies equally to any article on which a slippery surface having excellent hardness and resistance to wear is required (for example the hotplate of an iron).

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A multilayer non-stick coating for producing aluminum articles having increased resistance to scratching and wear, said coating including the following layers:
a hard first layer comprising mainly α alumina and a low percentage of γ alumina covered with a surface layer of mullite, such hard first layer being obtained by anodic oxidation of the aluminum article immersed in an alkaline solution during application of micro-arcs to said article by means of a high current and a high potential difference, said mullite layer being possibly partially or totally removed, said hard first layer having a porous nature,
a second polytetrafluoroethylene-based layer which constitutes a primer for
one or more polytetrafluoroethylene-based finished layers,
the particles of the primer second layer being lodged in pores present throughout the α alumina, γ alumina and possibly mullite hard first layer, so as to provide the coating with an extremely high resistance to scratching.

2. The coating claimed in claim 1 wherein said primer second layer further comprises at least one chemical anchoring agent.

3. The coating claimed in claim 1 wherein said primer second layer further comprises at least one technological agent.

4. The coating claimed in claim 1 wherein said hard first layer has a thickness in the range 5 microns to 100 microns.

5. The coating claimed in claim 1 wherein said primer second layer and said polytetrafluoroethylene-based finish layer(s) have a thickness in the range 5 microns to 50 microns.

6. The coating claimed in claim 1 wherein said alumina-based hard first layer is polished to remove some or all of the mullite.

7. The coating claimed in claim 6 wherein said hard first layer, after polishing until removal of all the mullite, has a Vickers hardness greater than about 1500.

8. An aluminum or aluminum alloy article having a coating as claimed in claim 1.

9. An aluminum or aluminum alloy culinary utensil having a coating as claimed in claim 1.

10. Method for manufacturing an aluminum article coated with a multilayer non-stick coating, said coated article having increased resistance to scratching and wear, said method including the following steps:
a) producing directly on an aluminum article a hard porous first layer comprising mainly α alumina and a low percentage of γ alumina covered with a surface layer of mullite, said hard porous first layer being produced by anodic oxidation of the aluminum article immersed in an alkaline solution during application of micro-arcs to said article by means of a high current and a high potential difference,
b) applying on this hard porous first layer a second polytetrafluoroethylene-based layer which constitutes a primer for one or more polytetrafluoroethylene-based finished layers, the particles of the primer second layer being lodged in pores present throughout the hard porous first layer, so as to provide the coating with an extremely high resistance to scratching,
c) applying thereto one or more polytetrafluoroethylene-based finished layers, and
d) sintering the coating thus obtained.

11. Method for manufacturing an aluminum article coated with a multilayer non-stick coating, said coated article having increased resistance to scratching and wear, said method including the following steps:
a) producing directly on the aluminum article a hard porous first layer comprising mainly α alumina and a low percentage of γ alumina covered with a surface layer of mullite, which hard porous first layer is produced by anodic oxidation of the aluminum article immersed in an alkaline solution during application of micro-arcs to said article by means of a high current and a high potential difference,
a′) polishing the hard porous first layer to remove some or all of the mullite layer,
b) applying to the polished hard first layer a second polytetrafluoroethylene-based layer which constitutes a primer for one or more polytetrafluoroethylene-based finished layers, the particles of the primer second layer being lodged in pores present throughout the hard first layer, so as to provide the coating with an extremely high resistance to scratching,
c) applying one or more polytetrafluoroethylene-based finished layers, and
d) sintering the coating thus obtained.

12. Method according claim 10 further including, after steps c) and/or d), a final step of polishing part of the coating obtained.
